(19) United States
(12) Patent Application Publication
(10) Pub. No.: US 2004/0187376 A1
(43) Pub. Date: Sep. 30, 2004

(54) Fishing rod displacement sensor and biting alarm

(76) Inventor: Luis Antonio Henriquez, Bridgeport, CT (US)

Correspondence Address: Stint, Inc., 61 Myrtle Ave., Bridgeport, CT, 06604, US

(21) Appl. No.: 10/731,188

(22) Filed: Dec. 9, 2003

Related U.S. Application Data
(60) Provisional application No. 60/457,285, filed on Mar. 26, 2003.

(51) Int. Cl. A01K 85/01

(52) U.S. Cl. 43/17

(57) ABSTRACT

A simple device signaling the change in a preset slope of an arbitrary elastic angling rod clamped at the lower end, at a preset location indicating a possible fish biting a bait or a lure by a sound or light.

The slope of the angling rod at its upper end where the device is attached, is preset by an angler so that the horizontal ball bearing level of the device is about horizontal. A fish bite causes an inclination of the horizontal ball bearing level and activation of a visual and/or audio alerting signal.

References
U.S. PATENTS

| | | | |
|---|---|---|---|
| 3,882,629 | May 1975 | Kaye. | 43/17 |
| 4,266,217 | May 1981 | Dai-Hae Kao et al. | 43/17 |
| 5,797,211 | August 1988 | Bae et al. | 43/17 |
| 5,228,228 | July 1993 | Meissner. | 43/17 |
| 6,446,380 | September 2002 | Radoslavljevich | 43/17 |

### BACKGROUND OF THE INVENTION

1. Field of the Invention

The present invention relates to a device sensing the change of a slope of a fishing rod at a selected point possibly due to a strike on the fishing line (“bite”). The device includes lighting and sounding means triggered if said changes exceed a preset threshold (“alarm”).

2. Description of the Prior Art

During the daytime a bite may be observed by an angler visually with the help of a bob-sinker system or a specific behavior of the fishing line sensed by a skilled angler. For night fishing various types of signaling devices have been known for millenia starting with tying a line's end to a finger or to a bell and finishing with technologically advanced instruments including sonars, rod bending gauges, and sophisticated levels some of which contain mercury and may contribute to an environmental pollution.

The need for an inexpensive and simple device with the right sensitivity that meets the expectations and needs of the public and is environmentally safe, remains. As long as the sensitivity of a device can be easily adjusted, an extremely sensitive device would simply send too many wrong alarms, and would not be practical. None of the above referred inventions appears to satisfy all the criteria for practicality or has won the substantial market share.

### SUMMARY OF THE INVENTION

It is an object of the present invention to provide the light source, a sound source, a battery to supply DC to said sources, and a ball bearing as a horizontal level, in the same housing mountable on a fishing rod at a specified point of said rod and at a specified angle to it.

Another object of the present invention is to provide the switch with three positions, the first position being for the power off, the second position being for connecting the sound source into the DC circuit with said battery, and the third position being for connecting the light source into the DC circuit for emitting light.

Still other objects will become apparent from the more detailed description of the preferred embodiment of the invention whereas various changes and modifications within the spirit and scope of the invention will become apparent to those skilled in the art from this description and dependent claims.

### BRIEF DESCRIPTION OF THE DRAWINGS

FIG. 1 depicts the assembly fastened to the fishing rod by mounting means;

FIG. 2 shows the slope change detector with signaling means in detail.

### DETAILED DESCRIPTION OF THE PREFERRED EMBODIMENT

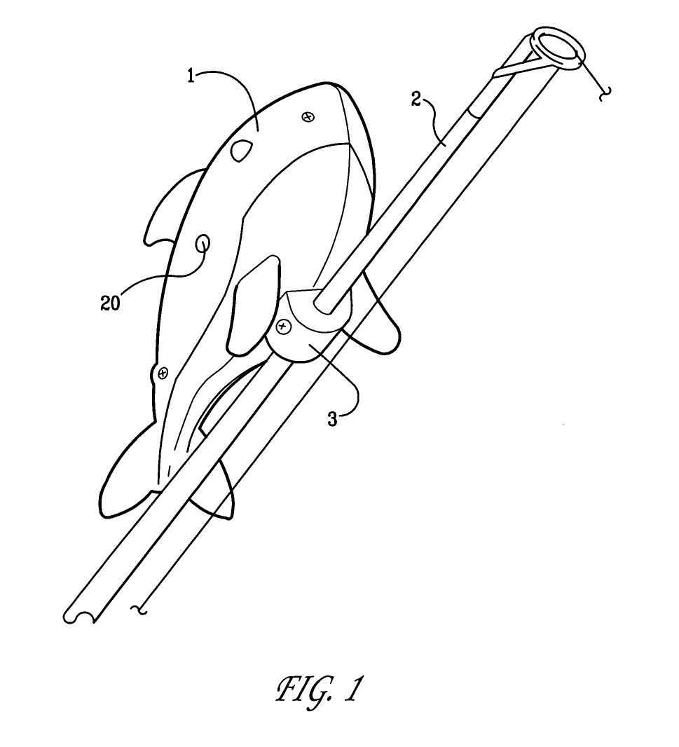

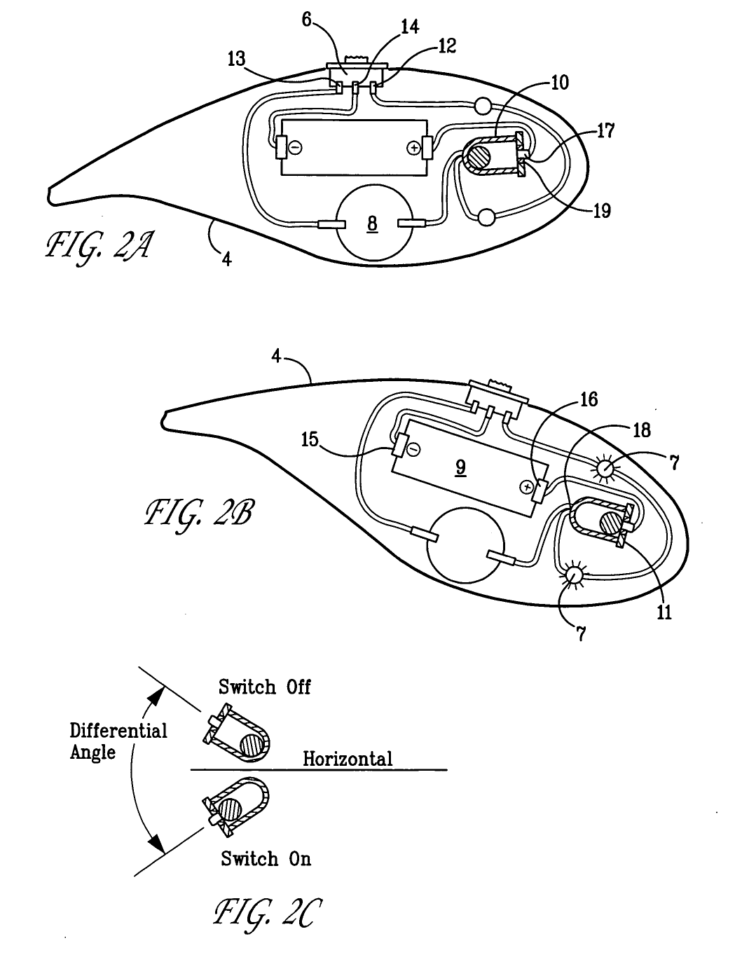

As shown in FIGS. 1 and 2 the invention includes a housing 4 with mounting means 3 for the rigid attachment thereof to the fishing rod 2. The shape of the housing 4 shown also as 1 resembles a fish.

The assembly includes the switch 6 with three positions 12, and 13 for forming, respectively, DC circuit with LED's 7 or with the sound means 8, and 14 for switching off the alarm. The power for the circuits may come from a battery 9 with two poles 15 and 16, said battery may be rechargeable.

The preferred horizontal level for the embodiment is a rigidly attached metallic cylindrical ball bearing 10 with a moving metallic ball 11 inside and two contacts at its ends, the first contact 17 isolated from the cylinder 10 by the annular plastic seal 19 being electrically connected to the first pole 15 of said battery 9 and having no electrical connection with the cylindrical metallic shell 10 to the seal 19, and the second contact 18 being electrically connected to the second pole 16 of said battery 9.

When the fishing rod 2 is positioned horizontally, the horizontal level 10 should be positioned in parallel, and when the fishing rod 2 is positioned at 45° to the ground, the horizontal level 10 should be perpendicular to said fishing rod. Instead of retuning the device each time the inclination of fishing rod 2 is changed, it is more practical to have both embodiments of the invention.

In either case, when a bite occurs, the ball 11 that is always in contact with the metallic cylinder 10 would also get in touch with the contact 15 as schematically indicated at the bottom of FIG. 2 b), thus activating either LEDs 7 or the speaker 8 depending on the choice of the switch position.

The LEDs 7 are positioned to imitate fish's eyes. The shell 4 has openings 20 for unimpeded sound propagation from the speaker 8 to the environment.

Clearly, the invention having been described as above can be varied in many ways without substantial change in its scope and spirit. All such modifications are believed to be included within the scope of the following claims claimed by the inventor:

1. A slope change detecting system with alarm comprising:
an attachment for mounting to an arbitrary spot on the fishing rod;
a housing fixedly connected thereto including a battery, a light source, and a speaker as alarming means;
a first switch for selecting a speaker;
a second switch for selecting a light alarm;
a ball bearing horizontal level;
a control circuit disposed in the housing and capable of activate either the speaker or the light alarm when a ball activates the corresponding circuit;

2. A housing for the detecting system of claim 1 and made from metal or plastic shaped as a fish like shell with openings for unobstructed sound propagation from said speaker, and with LEDs placed to imitate eyes of a fish.
